(19) United States
(12) Patent Application Publication
(10) Pub. No.: US 2023/0164551 A1
(43) Pub. Date: May 25, 2023

(54) WIRELESS COMMUNICATION APPARATUS AND VEHICLE INCLUDING THE SAME, AND WIRELESS COMMUNICATION SYSTEM

(71) Applicant: KABUSHIKI KAISHA TOKAI RIKA DENKI SEISAKUSHO, Aichi (JP)

(72) Inventors: Yosuke OHASHI, Aichi (JP); Keita SOBUE, Aichi (JP); Shingo MOCHIZUKI, Aichi (JP); Norihiro SHIMIZU, Aichi (JP)

(73) Assignee: KABUSHIKI KAISHA TOKAI RIKA DENKI SEISAKUSHO, Aichi (JP)

(21) Appl. No.: 17/912,701

(22) PCT Filed: Dec. 14, 2020
(86) PCT No.: PCT/JP2020/046486

§ 371 Date: Sep. 19, 2022

(30) Foreign Application Priority Data
Mar. 23, 2020 (JP) 2020-051348

(51) Int. Cl. H04W 12/06; H04B 5/02

(52) U.S. Cl. CPC H04W 12/06; H04B 5/02

(57) ABSTRACT

A vehicle includes: an NFC communication device by a communication scheme in accordance with NFC standards; a BLE communication device by a communication scheme in accordance with BLE communication standards; and a wireless controller that controls the NFC communication device and the BLE communication device. Each of the NFC communication device and the BLE communication device is configured to perform polling for detecting a mobile device and to perform authentication of the mobile device detected by the polling. When the authentication is completed in one of the NFC communication device and the BLE communication device, the wireless controller stops the polling by the other communication device.

### TECHNICAL FIELD

The present disclosure relates to a wireless communication apparatus and a vehicle including the same, and a wireless communication system.

### BACKGROUND ART

There are known techniques for performing functions such as unlocking and locking doors of a vehicle, a house and the like with a mobile device such as a smartphone. Japanese Patent Laying-Open No. 2013-100645 (PTL 1), for example, discloses a wireless communication system including a mobile device and an in-vehicle communication device that are capable of bidirectional communication. In this wireless communication system, wireless communication is performed between the mobile device and the in-vehicle communication device by near field communication (NFC) (for example, wireless communication by a communication scheme in accordance with NFC standards; hereinafter referred to as “NFC communication” or simply as “NFC” and the like) and the like, to allow unlocking and locking of vehicle doors or starting of an engine from the mobile device (see PTL 1).

### CITATION LIST

### Patent Literature

PTL 1: Japanese Patent Laying-Open No. 2013-100645

### SUMMARY OF INVENTION

### Technical Problem

In a wireless communication system such as described above, in order to detect that a user carrying a mobile device is approaching a vehicle and the like, polling for detecting the mobile device is performed in a communication device provided in the vehicle and the like. If a dark current associated with this polling is large, problems may arise such as unintentional depletion of a battery that supplies operating power to the communication device.

The present disclosure has been made to solve such a problem, and has an object to reduce a dark current in a wireless communication apparatus including a communication device that conducts wireless communication with a mobile device, a vehicle including the wireless communication apparatus, and a wireless communication system.

### Solution to Problem

A wireless communication apparatus according to the present disclosure includes a plurality of communication devices that conduct wireless communication by communication schemes different from each other, and a controller that controls the plurality of communication devices. Each of the plurality of communication devices is configured to perform polling for detecting a mobile device capable of wireless communication, and to perform authentication of the mobile device detected by the polling. When the authentication is completed in one of the plurality of communication devices, the controller stops the polling by a remaining communication device.

A wireless communication system according to the present disclosure includes a wireless communication apparatus, and a mobile device that conducts wireless communication with the wireless communication apparatus. The wireless communication apparatus includes a plurality of communication devices that conduct wireless communication by communication schemes different from each other, and a controller that controls the plurality of communication devices. Each of the plurality of communication devices is configured to perform polling for detecting the mobile device, and to perform authentication of the mobile device detected by the polling. When the authentication is completed in one of the plurality of communication devices, the controller stops the polling by a remaining communication device.

The wireless communication apparatus described above includes the plurality of communication devices, and when the authentication of the mobile device is completed in one of the plurality of communication devices, the polling by a remaining communication device is stopped because the communication between the remaining communication device and the mobile device is no longer necessary. As a result, a dark current associated with the polling can be reduced.

### Advantageous Effects of Invention

According to a wireless communication apparatus and a vehicle including the same, and a wireless communication system in the present disclosure, a dark current can be reduced.

### BRIEF DESCRIPTION OF DRAWINGS

FIG. 1 is an overall block diagram of a wireless communication system according to an embodiment of the present disclosure.

FIG. 2 is a timing chart showing example polling by a BEE communication device and an NFC communication device of a vehicle.

FIG. 3 is a timing chart showing another example polling by the NFC communication device and the BLE communication device of the vehicle.

FIG. 4 is a flowchart showing an example procedure for a process performed by a wireless controller of the vehicle.

### DESCRIPTION OF EMBODIMENTS

An embodiment of the present disclosure will be described in detail hereinafter with reference to the drawings, in which the same or corresponding portions are denoted by the same reference characters and description thereof will not be repeated.

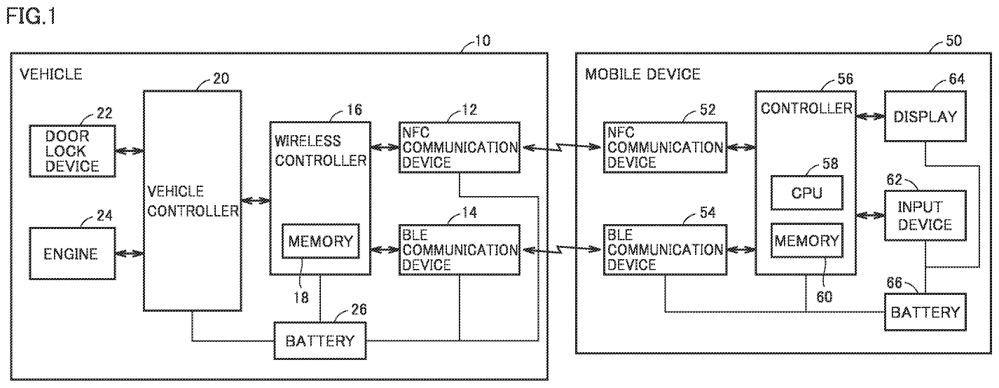

FIG. 1 is an overall block diagram of a wireless communication system according to an embodiment of the present disclosure. Referring to FIG. 1, the wireless communication system includes a vehicle 10 and a mobile device 50. Vehicle 10 includes an NFC communication device 12, a Bluetooth Low Energy (BEE) (“Bluetooth” is a registered trademark) communication device 14, and a wireless controller 16. NFC communication device 12, BLE communication device 14, and wireless controller 16 constitute a wireless communication apparatus that conducts wireless communication with mobile device 50.

NFC communication device 12 is a communication device that conducts wireless communication with mobile device 50 by a communication scheme in accordance with NFC standards. NFC communication device 12 operates with power supplied from a battery 26, and conducts NFC communication with an NEC communication device 52 of mobile device 50 through an antenna not shown in the figure. Among the NFC communication functions, at least reader/writer functions are incorporated in NFC communication device 12. In addition to the reader/writer functions, a peer-to-peer communication (P2P) function may be incorporated.

NFC communication device 12 performs polling for detecting mobile device 50, in accordance with an instruction from wireless controller 16. That is, NFC communication device 12 transmits a request signal to the surroundings at regular intervals in accordance with NEC standards, and receives a response signal transmitted from NFC communication device 52 of mobile device 50 in response to the request signal. Upon receiving the response signal, NFC communication device 12 demodulates authentication data (ID information) included in the response signal, and outputs the demodulated ID information to wireless controller 16.

BLE communication device 14 is a communication device that conducts wireless communication with mobile device 50 by a communication scheme in accordance with BLE communication standards. BLE communication device 14 also operates with power supplied from battery 26, and conducts BLE communication with a BLE communication device 54 of mobile device 50 through an antenna not shown in the figure. The BLE communication has a communicable range of several meters or more, which is larger than a communicable range of the NFC communication (about 10 cm).

BLE communication device 14 also performs polling for detecting mobile device 50, in accordance with an instruction from wireless controller 16. That is, BLE communication device 14 transmits a request signal to the surroundings at regular intervals in accordance with BLE communication standards, and receives a response signal transmitted from BLE communication device 54 of mobile device 50 in response to the request signal. Upon receiving the request signal, BLE communication device 14 demodulates authentication data (ID information) included in the response signal, and outputs the demodulated ID information to wireless controller 16.

Wireless controller 16 includes a processor not shown in the figure and a memory 18, and controls NFC communication device 12 and BLE communication device 14. Specifically, when a prescribed polling condition is satisfied, wireless controller 16 outputs a command to perform polling to NFC communication device 12 and BLE communication device 14 (polling process).

When wireless controller 16 receives the ID information received and demodulated by NFC communication device 12 or BLE communication device 14, wireless controller 16 verifies the ID information against ID information stored in memory 18 (authentication process). If the received ID information and the stored ID information are determined to match as a result of the verification, the authentication of mobile device 50 is completed. As a result, authenticated mobile device 50 can be used to perform operation of a door lock device 22 (locking/unlocking of entrance doors), start an engine 24, or the like. The ID information stored in memory 18 may be stored in a memory (not shown) of a vehicle controller 20, or in each of NFC communication device 12 and BLE communication device 14. The process of wireless controller 16 will be described later in further detail.

Vehicle 10 further includes vehicle controller 20, door lock device 22, engine 24, and battery 26. Door lock device 22 is configured to switch the entrance doors of vehicle 10 between a locked state and an unlocked state. Engine 24 is an internal combustion engine that generates a driving force for vehicle 10 to run.

Vehicle controller 20 includes a central processing unit (CPU), a memory, signal input/output ports, and the like (none shown). Vehicle controller 20 performs various types of control of vehicle 10. As an example, vehicle controller 20 outputs an unlock command to door lock device 22 in accordance with a request to unlock the entrance doors, and outputs a lock command to door lock device 22 in accordance with a request to lock the entrance doors. Vehicle controller 20 also performs control of starting of engine 24 in accordance with a request to start engine 24.

When vehicle controller 20 receives a notification that the authentication of mobile device 50 is completed from wireless controller 16, vehicle controller 20 permits the operation of door lock device 22 (locking/unlocking of the doors) and the starting of engine 24 with authenticated mobile device 50. Then, when the operation of door lock device 22 or the starting of engine 24 is requested with mobile device 50, vehicle controller 20 controls door lock device 22 or engine 24 to perform the requested operation.

Battery 26 is an auxiliary battery of vehicle 10, and implemented, for example, by a lead acid battery. Battery 26 supplies operating power to NFC communication device 12, BLE communication device 14, wireless controller 16, and vehicle controller 20.

Mobile device 50 includes NFC communication device 52, BLE communication device 54, a controller 56, an input device 62, a display 64, and a battery 66.

NFC communication device 52 is a communication device that conducts wireless communication with vehicle 10 by a communication scheme in accordance with NFC standards. NFC communication device 52 conducts NFC communication with NFC communication device 12 of vehicle 10 through an antenna not shown in the figure. NFC communication device 52 includes a passive tag (IC tag) that operates by radio waves from NFC communication device 12. That is, NFC communication device 52 operates by radio waves received from NFC communication device 12 without receiving power supply from battery 66. Accordingly, NFC communication device 52 can communicate with NFC communication device 12 of vehicle 10 even when mobile device 50 is powered off.

When NFC communication device 52 receives the request signal emitted from NFC communication device 12, NFC communication device 52 generates a response signal including ID information that is unique to corresponding mobile device 50 and was written in the passive tag (IC tag), modulates the generated response signal, and transmits the modulated response signal to NFC communication device 12 of vehicle 10.

BLE communication device 54 is a communication device that conducts wireless communication with vehicle 10 by a communication scheme in accordance with BLE communication standards. BLE communication device 54 operates with power supplied from battery 66, and conducts BLE communication with BLE communication device 14 of vehicle 10 through an antenna not shown in the figure.

When BLE communication device 54 receives the request signal emitted from BLE communication device 14, BLE communication device 54 obtains ID information that is unique to corresponding mobile device 50 from a memory 60 of controller 56. BLE communication device 54 then generates a response signal including the obtained ID information, modulates the generated response signal, and transmits the modulated response signal to BLE communication device 14 of vehicle 10.

Controller 56 includes a CPU 58, memory 60, signal input/output ports (not shown), and the like. Controller 56 performs various types of control of mobile device 50. As an example, controller 56 reads, in accordance with a request from BLE communication device 54, the ID information of corresponding mobile device 50 stored in memory 60 from memory 60, and outputs the read ID information to BLE communication device 54. When an input operation that requests the unlocking/locking by door lock device 22 or the starting of engine 24 in vehicle 10 is performed at input device 62, controller 56 outputs a signal corresponding to the input operation to BLE communication device 54.

Input device 62 is a device that accepts various input operations by a user on mobile device 50, and implemented, for example, by a touch sensor that detects touch operations on display 64, or various operation buttons provided on mobile device 50. Display 64 displays various types of information of mobile device 50, information corresponding to an input operation from input device 62, and the like. Input device 62 and display 64 may be integrally formed as a touch panel sensor.

Battery 66 is a chargeable and dischargeable secondary battery, and implemented, for example, by a lithium ion secondary battery. Battery 66 can be charged by an external power supply using a charging device not shown in the figure. Battery 66 then supplies operating power to BLE communication device 54, controller 56, input device 62, and display 64.

Since NFC communication device 52 includes a passive tag that operates by radio waves from NFC communication device 12 as described above, NFC communication device 52 does not receive power supply from battery 66.

In this wireless communication system, mobile device 50 can be used to perform the operation of door lock device 22 (locking/unlocking of the entrance doors), or the starting of engine 24, in vehicle 10. A representative description of the operation of door lock device 22 is provided. When an input operation that requests the unlocking or locking by door lock device 22 is performed at input device 62 after BLE communication has been established between BLE communication devices 14 and 54, and authentication of mobile device 50 has been completed through the BLE communication, a signal corresponding to the input operation is transmitted from BLE communication device 54 to BLE communication device 14, and door lock device 22 is controlled by vehicle controller 20 in accordance with this signal in vehicle 10.

When a predetermined operation that requests the unlocking or locking by door lock device 22 is performed after NFC communication has been established between NFC communication devices 12 and 52, and authentication of mobile device 50 has been completed through the NFC communication, door lock device 22 is controlled by vehicle controller 20 in accordance with this operation in vehicle 10. For example, by holding mobile device 50 over a prescribed position and allowing the communication between NFC communication devices 12 and 52 to continue for at least a prescribed period of time, the locking and unlocking by door lock device 22 can be switched in accordance with this operation.

In the wireless communication system described above, NFC communication between NFC communication devices 12 and 52 and BLE communication between BLE communication devices 14 and 54 can be used. As to the NFC communication and the BLE communication, the BLE communication has a larger communicable range than the NFC communication. When mobile device 50 is powered off, on the other hand, the operating power is not supplied from battery 66 to BLE communication device 54, and therefore, the BLE communication cannot be used. However, the passive type NFC communication that does not require power supply from battery 66 can be used.

For the communication between vehicle 10 and mobile device 50, therefore, the BLE communication between BLE communication devices 14 and 54 with a larger communicable range is basically used, and the NFC communication between NFC communication devices 12 and 52 is used as a backup when the BLE communication cannot be used because mobile device 50 is powered off due to a dead battery or the like.

Whether in the NFC communication or in the BLE communication, in order to detect that the user carrying mobile device 50 is approaching vehicle 10, polling for detecting mobile device 50 is performed in NFC communication device 12 and BLE communication device 14 of vehicle 10. During the polling, radio waves (request signal) are output to the surroundings at regular intervals in order to detect mobile device 50 approaching vehicle 10, causing a dark current to flow. If the dark current associated with this polling is high, problems may arise such as unintentional depletion of battery 26.

In the wireless communication system according to the present embodiment, therefore, once the communication is established either between BLE communication devices 14 and 54 or between NFC communication devices 12 and 52, and the authentication of mobile device 50 is completed, wireless controller 16 stops the polling by the communication devices used for the other communication because the other communication is no longer necessary. As a result, after the authentication is completed in one of the BLE communication and the NFC communication, the dark current associated with the polling can be reduced in the communication devices used for the other communication.

While the functions authorized when the authentication has been performed in the BLE communication and the functions authorized when the authentication has been performed in the NFC communication do not necessarily need to match completely, at least some of the functions overlap. For example, the function of locking/unlocking the entrance doors is authorized both when the authentication has been performed in the BLE communication and when the authentication has been performed in the NFC communication. As a result, a situation is avoided where the locking/unlocking of the entrance doors cannot be performed due to the stop of the polling in the communication that was determined to be unnecessary.

The stopped polling is resumed when a prescribed polling condition is satisfied. The polling condition can be satisfied, for example, when operating engine 24 is stopped, an ignition key or the like is turned off, which leads to a Ready-Off state, and an occupant gets out of the car and locks the doors.

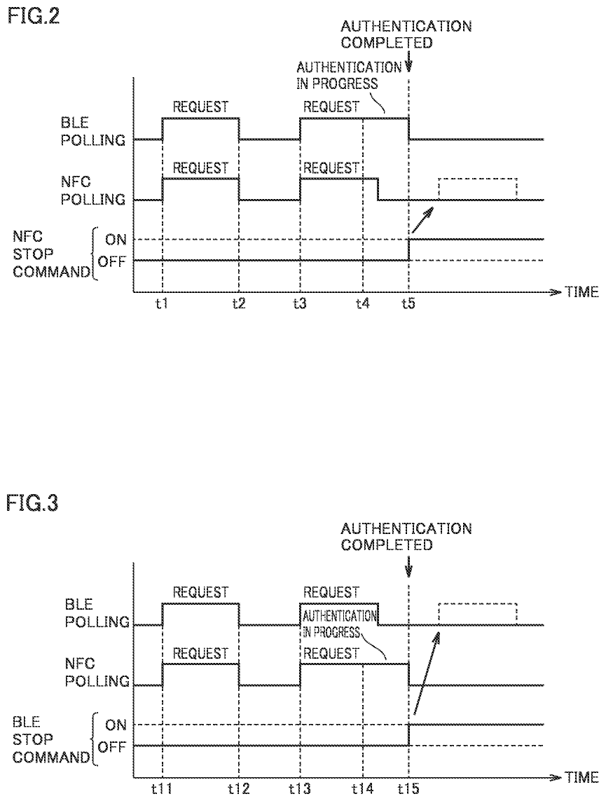

FIG. 2 is a timing chart showing example polling by BLE communication device 14 and NFC communication device 12 of vehicle 10. Referring to FIG. 2, the polling condition is satisfied before time t1, and a request signal is emitted from each of BLE communication device 14 and NFC communication device 12 to the surroundings between times t1 and t2.

Even before time t1, such request signals are emitted at regular intervals after the polling condition is satisfied. In this example, polling by BLE communication device 14 (which may be hereinafter referred to as “BLE polling”) and polling by NFC communication device 12 (which may be hereinafter referred to as “NFC polling”) are synchronized. However, the BLE polling and the NFC polling do not necessarily need to be synchronized, and the request signals do not necessarily need to have the same length, either.

At time t4, in the BLE communication with a wider communicable range, a response signal transmitted from BLE communication device 54 of mobile device 50 in response to the request signal is received by BLE communication device 14, and ID information included in the response signal is verified (“authentication in progress”). Then, when the authentication of mobile device 50 is completed at time t5, wireless controller 16 stops the NFC polling by outputting an NFC stop command to NFC communication device 12. As a result, after the authentication is completed in the BLE communication, a dark current associated with the polling can be reduced.

FIG. 3 is a timing chart showing another example polling by BLE communication device 14 and NFC communication device 12 of vehicle 10. This FIG. 3 shows an example in which mobile device 50 is powered off (a dead battery or the like).

Referring to FIG. 3, also in this example, the polling condition is satisfied before time t11, and a request signal is emitted from each of BLE communication device 14 and NFC communication device 12 to the surroundings between times t11 and t12. Even before time t11, the request signals are emitted at regular intervals after the polling condition is satisfied.

In this example, BLE communication device 54 is stopped because mobile device 50 is powered off, and the response signal is not transmitted from BLE communication device 54 for the BLE polling. The user then moves closer to vehicle 10, and at time t14, a response signal transmitted from NEC communication device 52 of mobile device 50 in response to the request signal from NFC communication device 12 is received by NFC communication device 12, and ID information included in the response signal is verified (“authentication in progress”). Since NFC communication device 52 is a passive type communication device that does not require power feed from battery 66, NFC communication device 52 can transmit the response signal to NFC communication device 12 of vehicle 10 in response to the request signal from NFC communication device 12, even when mobile device 50 is powered off.

Then, when the authentication of mobile device 50 is completed at time t15, wireless controller 16 stops the BLE polling by outputting a BLE stop command to BLE communication device 14. As a result, after the authentication is completed in the NFC communication, a dark current due to the polling can be reduced.

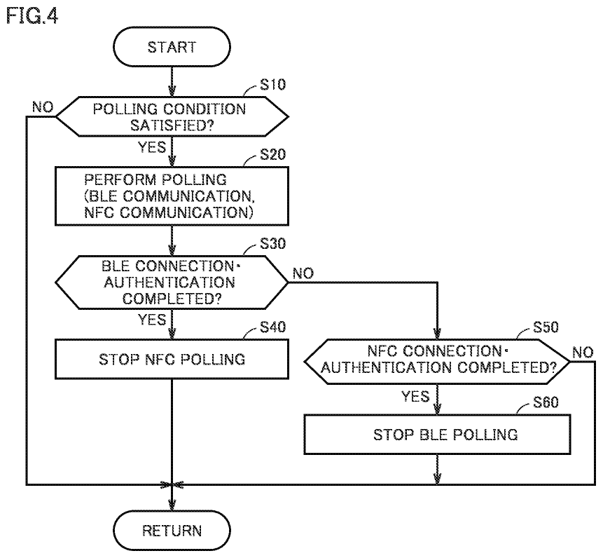

FIG. 4 is a flowchart showing an example procedure for a process performed by wireless controller 16 of vehicle 10. A series of process steps shown in this flowchart is repeated at regular intervals.

Referring to FIG. 4, wireless controller 16 determines whether or not a polling condition for BLE communication device 14 and NFC communication device 12 to perform polling is satisfied (step S10). The polling condition can be satisfied, for example, when operating engine 24 is stopped, which leads to a Ready-Off state of vehicle 10, and the occupant gets out of the car and then locks the doors. When the polling condition is not satisfied (NO in step S10), the process proceeds to “return.”

When it is determined in step S10 that the polling condition is satisfied (YES in step S10), wireless controller 16 outputs a command to perform polling to both BLE communication device 14 and NFC communication device 12 (step S20). As a result, each of BLE communication device 14 and NFC communication device 12 emits a request signal to the surroundings at regular intervals.

Then, wireless controller 16 determines whether or not communication has been established between BLE communication devices 14 and 54, and authentication of mobile device 50 has been completed through the BLE communication (step S30). Specifically, a response signal transmitted from BLE communication device 54 of mobile device 50 in response to the request signal from BLE communication device 14 is received by BLE communication device 14, and based on a result of verification of ID information included in the response signal, it is determined whether or not the authentication of mobile device 50 has been completed.

Then, when it is determined in step S30 that the authentication of mobile device 50 has been completed through the BLE communication (YES in step S30), wireless controller 16 stops the polling (NFC polling) by NFC communication device 12 (step S40).

When it is determined in step S30 that the communication has not been established between BLE communication devices 14 and 54, and the authentication of mobile device 50 has not been completed (NO in step S30), on the other hand, wireless controller 16 determines whether or not communication has been established between NFC communication devices 12 and 52, and authentication of mobile device 50 has been completed through the NFC communication (step S50). Specifically, a response signal transmitted from NFC communication device 52 of mobile device 50 in response to the request signal from NFC communication device 12 is received by NFC communication device 12, and based on a result of verification of ID information included in the response signal, it is determined whether or not the authentication of mobile device 50 has been completed.

Then, when it is determined in step S50 that the authentication of mobile device 50 has been completed through the NFC communication (YES in step S50), wireless controller 16 stops the polling (BLE polling) by BLE communication device 14 (step S60).

The case where the authentication is not completed in the BLE communication (NO in step S30) and the authentication is completed in the NFC communication (YES in step S50) corresponds to the case where NFC communication is used as a backup when BLE communication cannot be used because mobile device 50 is powered off, as was explained in FIG. 3.

When it is determined in step S50 that the communication has not been established between NFC communication devices 12 and 52, and the authentication of mobile device 50 has been completed (NO in step S50), the process proceeds to “return.”

In the description above, it is determined in step S30 whether or not the connection and the authentication for BLE communication has been completed, and when the determination is NO in step S30, it is determined in step S50 whether or not the connection and the authentication for NFC communication has been completed. However, these processes may be performed in reverse order or in parallel.

That is, although not particularly illustrated, after the process of step S20 is performed, wireless controller 16 may determine whether or not the connection and the authentication for NFC communication has been completed, and when it is determined that the connection and the authentication for NFC communication has not been completed, wireless controller 16 may determine whether or not the connection and the authentication for BLE communication has been completed. Then, when it is determined that the connection and the authentication for NFC communication has been completed, the BLE polling may be stopped, and when it is determined that the connection and the authentication for BLE communication has been completed, the NFC polling may be stopped.

After the process of step S20 is performed, wireless controller 16 may perform the process of step S30 and the process of step S50 in parallel or even simultaneously. Then, when the determination is YES in step S30, the NFC polling may be stopped in step S40, and when the determination is YES in step S50, the BLE polling may be stopped in step S60.

As described above, in the present embodiment, when the communication between BLE communication devices 14 and 54 is established, and the authentication of mobile device 50 is completed in the BLE communication, the polling by NFC communication device 12 is stopped because the NFC communication as a backup is no longer necessary. When the communication between BLE communication devices 14 and 54 is not established because mobile device 50 is powered off, and the authentication of mobile device 50 is completed in the NFC communication as a backup, on the other hand, the polling by BLE communication device 14 is stopped. According to the present embodiment, therefore, a dark current due to the polling can be reduced.

While vehicle 10 is a vehicle with engine 24 in the embodiment above, the scope of the present disclosure is not limited to vehicles with an engine, and also includes electric vehicles, fuel cell vehicles and the like without an engine.

While NFC communication device 52 is mounted on mobile device 50 in the embodiment above, NFC communication device 52 may be mounted on a card or the like not having a power supply, that is separate from mobile device 50. While NFC communication device 52 includes a passive tag (IC tag) that operates by radio waves from NFC communication device 12 in the description above, NFC communication device 52 is not limited to a passive type communication device, and may operate with power received from battery 66.

While wireless controller 16 is provided separately from vehicle controller 20 in vehicle 10 in the embodiment above, vehicle controller 20 may include the functions of wireless controller 16.

In the embodiment above, both vehicle 10 and mobile device 50 may include, instead of BLE communication devices 14 and 54, ultra-wide band (UWB) communication devices that conduct wireless communication by a communication scheme in accordance with UWB communication standards. Alternatively, both vehicle 10 and mobile device 50 may include the UWB communication devices in addition to BLE communication devices 14 and 54.

While NFC communication device 12, BLE communication device 14, and wireless controller 16 are mounted on vehicle 10 in the embodiment above, the scope of the present disclosure is not limited to wireless communication apparatuses mounted on a vehicle. For example, NFC communication device 12, BLE communication device 14, and wireless controller 16 may be provided in a house or a home delivery box, and mobile device 50 may be used as a key to lock/unlock a door of the house or the home delivery box.

It should be understood that the embodiment disclosed herein is illustrative and non-restrictive in every respect. The technical scope indicated by the present disclosure is defined by the terms of the claims, rather than the description of the embodiment above, and is intended to include any modifications within the scope and meaning equivalent to the terms of the claims.

The illustrative embodiment described above is a specific example of aspects described below.

A wireless communication apparatus in one aspect includes a plurality of communication devices that conduct wireless communication by communication schemes different from each other, and a controller that controls the plurality of communication devices. Each communication device is configured to perform polling for detecting a mobile device capable of wireless communication, and to perform authentication of the mobile device detected by the polling. When the authentication is completed in one of the plurality of communication devices, the controller stops the polling by a remaining communication device.

A wireless communication system in one aspect includes a wireless communication apparatus, and a mobile device that conducts wireless communication with the wireless communication apparatus. The wireless communication apparatus includes a plurality of communication devices that conduct wireless communication by communication schemes different from each other, and a controller that controls the plurality of communication devices. Each communication device is configured to perform polling for detecting the mobile device, and to perform authentication of the mobile device detected by the polling. When the authentication is completed in one of the plurality of communication devices, the controller stops the polling by a remaining communication device.

In the wireless communication apparatus and the wireless communication system described above, when the authentication of the mobile device is completed in one of the plurality of communication devices, the polling by a remaining communication device is stopped because the communication between the remaining communication device and the mobile device is no longer necessary. As a result, a dark current associated with the polling can be reduced.

The plurality of communication devices may include an NFC communication device by a communication scheme in accordance with NFC standards, and at least one communication device by a communication scheme in accordance with wireless communication standards different from the NFC standards. When the authentication is completed in one of the at least one communication device, the controller may stop the polling by the NFC communication device.

The at least one communication device may include at least one of a BLE communication device by a communication scheme in accordance with BLE communication standards, and a UWB communication device by a communication scheme in accordance with UWB communication standards.

While the communication scheme in accordance with NFC standards has a smaller communicable range than the communication scheme in accordance with BLE communication standards or UWB communication standards, the communication scheme in accordance with NFC standards is a passive type that does not require a power supply. In the aspect above, therefore, the NFC communication device is used as a backup for the BLE communication device or the UWB communication device. According to the aspect above, when the authentication is completed in the BLE communication device or the UWB communication device, the polling by the NFC communication device as a backup is stopped, whereby a dark current due to the polling can be reduced.

At least some of functions authorized by the authentication in each communication device may overlap at least some of functions authorized by the authentication in the remaining communication device.

As a result, a situation is avoided where none the functions can be performed that are authorized by the authentication in the communication device where the polling is stopped.

The wireless communication apparatus may be mounted on a vehicle, and the functions authorized by the authentication in each communication device may include unlocking and locking of a door of the vehicle with the mobile device.

As a result, even when the polling by one communication device is stopped, and the communication with this communication device is no longer conducted, the door of the vehicle can be unlocked and locked with the mobile device through another communication device that was used for communication and authentication.

### REFERENCE SIGNS LIST

10 vehicle; 12, 52 NFC communication device; 14, 54 BLE communication device; 16 wireless controller; 18, 60 memory; 20 vehicle controller; 22 door lock device; 24 engine; 26, 66 battery; 50 mobile device; 56 controller; 58 CPU; 62 input device; 64 display.

1. A wireless communication apparatus comprising:
a plurality of communication devices that conduct wireless communication by communication schemes different from each other; and
a controller that controls the plurality of communication devices, wherein
each of the plurality of communication devices is configured to perform polling for detecting a mobile device capable of wireless communication, and to perform authentication of the mobile device detected by the polling, and
when the authentication is completed in one of the plurality of communication devices, the controller stops the polling by a remaining communication device.

2. The wireless communication apparatus according to claim 1, wherein
the plurality of communication devices include
an NFC communication device by a communication scheme in accordance with near field communication standards, and
at least one communication device by a communication scheme in accordance with wireless communication standards different from the near field communication standards, and
when the authentication is completed in one of the at least one communication device, the controller stops the polling by the NFC communication device.

3. The wireless communication apparatus according to claim 2, wherein
the at least one communication device includes at least one of a BLE communication device by a communication scheme in accordance with BLE communication standards, and a UWB communication device by a communication scheme in accordance with UWB communication standards.

4. The wireless communication apparatus according to claim 1, wherein
at least some of functions authorized by the authentication in each of the plurality of communication devices overlap at least some of functions authorized by the authentication in the remaining communication device.

5. The wireless communication apparatus according to claim 4, wherein
the wireless communication apparatus is mounted on a vehicle, and
the functions authorized by the authentication in each of the plurality of communication devices include unlocking and locking of a door of the vehicle with the mobile device.

6. A vehicle comprising the wireless communication apparatus according to claim 1.

7. A wireless communication system comprising:
a wireless communication apparatus; and
a mobile device that conducts wireless communication with the wireless communication apparatus, wherein
the wireless communication apparatus includes
a plurality of communication devices that conduct wireless communication by communication schemes different from each other, and
a controller that controls the plurality of communication devices,
each of the plurality of communication devices is configured to perform polling for detecting the mobile device, and to perform authentication of the mobile device detected by the polling, and
when the authentication is completed in one of the plurality of communication devices, the controller stops the polling by a remaining communication device.

8. The wireless communication system according to claim 7, wherein
the plurality of communication devices include
an NFC communication device by a communication scheme in accordance with near field communication standards, and
at least one communication device by a communication scheme in accordance with wireless communication standards different from the near field communication standards, and
when the authentication is completed in one of the at least one communication device, the controller stops the polling by the NFC communication device.

9. The wireless communication system according to claim 7, wherein
the wireless communication apparatus is mounted on a vehicle, and
functions authorized by the authentication in each of the plurality of communication devices include unlocking and locking of a door of the vehicle with the mobile device.
